(19) United States
(12) Patent Application Publication
(10) Pub. No.: US 2009/0074958 A1
(43) Pub. Date: Mar. 19, 2009

(54) Polymeric nanocompositions comprising self-assembled organic quantum dots

(76) Inventor: Dequan Xiao, Durham, NC (US)

Correspondence Address: Dequan Xiao, 1315 Morreene Road, Apt 2G, Durham, NC, 27705, US

(21) Appl. No.: 12/208,307

(22) Filed: Sep. 10, 2008

Related U.S. Application Data
(60) Provisional application No. 60/972,213, filed on Sep. 13, 2007.

(51) Int. Cl. B05D 5/06; C08F 26/06; C08F 220/26; C08F 20/04; C08F 228/02; C08F 20/44

(52) U.S. Cl. 427/157; 526/263; 526/320; 526/317.1; 526/287; 526/341; 977/774

(57) ABSTRACT

The present invention relates to a polymeric nanocomposition of matter comprising a plurality of organic quantum dots. The composition includes at least one functionalized polymer chain template and a plurality of size-tunable organic quantum dots self-assembled onto the functionalized polymer chain template. The self-assembled organic quantum dots may be nanometer-scale molecular aggregates with size tunable by the functionalized polymer chain template. The polymer nanocomposite may be coated onto the surface of Ag or Au nanoparticles to achieve surface enhanced properties, such as, surface enhanced Raman effect. One embodiment of the polymer nanocomposites has shown unusual physicochemical property, which is especially suitable for use in optical devices including optical fibers, waveguides, Raman amplifiers, splitters, multiplexers, demultiplexers, attenuators, modulators, switches, and combination of such structures.

### FIELD OF THE INVENTION

The present invention pertains to polymeric nanocompositions comprising size-tunable self-assembled organic quantum dots, to methods of their preparation and their use. Polymeric nanocomposites comprising organic quantum dots prepared through self-assembly in this invention have unusual physicochemical characteristics.

### BACKGROUND OF THE INVENTION

In condensed matters, due to the quantum confinement effect, when the size of atomic clusters approaches a very small size, e.g. 1.0 nm to 300 nm, the physical properties of the atomic clusters change dramatically from their corresponding bulk solids (Murray, C. B., Kagan, C. R., Bawendi, M. G., Science, 1995, 270, 1335; Nirmal, M., Brus, L., Acc. Chem. Res. 1999, 32, 407). For example, with the increasing of atomic cluster sizes (from 1.0 nm to 300 nm), the electronic energy band gaps decrease, optical absorption spectrum shift to longer wavelength, and photoluminescence wavelength shift toward longer wavelength. These nanometer-scale atomic clusters are referred to as quantum dots, nanoparticles or nanocrystals. Many applications have been developed using quantum dots, for example, to provide optical amplification, saturable absorption, nonlinear effects, or biosensors.

The commonly synthesized quantum dots are nanometer-scale particles (Murray, C. B., Kagan, C. R., Bawendi, M. G., Science, 1995, 270, 1335; Nirmal, M., Brus, L., Acc. Chem. Res. 1999, 32, 407) made of inorganic materials, such as inorganic metal, dielectric and semiconductor materials. For examples, inorganic quantum dots, CdSe, ZnSe, or PbS and have been manufactured in solid hosts, films, suspensions or other material formats.

Analogous to inorganic quantum dots, organic quantum dots (He et al., J. Am. Chem. Soc. 2004, 126, 7792; Wang, F. et al., J. Am. Chem. Soc. 2005, 127, 10350; An, B. K. et al., J. Am. Chem. Soc. 2002, 124, 14410) may also be manufactured from organic materials (molecular compounds containing the element carbon with covalent bonds). In contrast to the atomic clusters of inorganic quantum dots, organic quantum dots may be the nanometer-scale molecular clusters. The basic repeat units in organic quantum dots are molecules or molecular moieties instead of atoms.

It is desirable that organic quantum dots can possess additional advantages over the inorganic quantum dots. First, organic quantum dots can have much more varieties in species considering that the number of classes of organic molecules is significantly greater than inorganic compounds. Second, organic quantum dots are readily for chemical modification through chemical reactions. In addition, organic quantum dots may have much better biocompatibility than inorganic quantum dots for use as biosensors. Hence, there is a need for manufacturing nanocomposites comprising size-tunable organic quantum dots.

The great challenge for organic quantum dots is to manufacture structurally stable organic molecular aggregates with size controlled in nanometer-scale. The literature related to formation of organic quantum dots is limited. Especially, there are few literatures relating to nanocomposite materials having size-tunable organic quantum dots.

One example related to thin films of organic nanocrystal super lattice prepared by precipitation from liquid solvents (U.S. Pat. No. 7,097,902 to Blanton, et al.). The organic nanocrystal super lattices are thin film materials. Another example related to the organic quantum dots using core-spacer structures to prevent the organic molecules from aggregating into bulk solids (He et al., J. Am. Chem. Soc. 2004, 126, 7792). The quantum-dot-like properties are discovered for these molecular clusters. For examples, the energy gaps vary, and optical absorption band shifts in the spectrum. Particularly, the broadening of Raman shifts has been noticed for these organic quantum dots.

The third example relating to the organic quantum dots is the H— or J-aggregates (A. Herz, Photog. Sci. Eng., 1974, 18, 323; E. Jelley, Nature, 1936, 138, 1009) of dye compounds made via either Langmuir-Blodgett monolayer or self-assembly of dye compounds and polymer chains. It is known that nanometer-scale molecular aggregates of certain dyes can be generated dynamically when they clustered in solution. The internal structure of the aggregates is identified by the gradual shift of the absorption spectra to shorter wavelength (in the case of H-aggregates) or a sudden shift to longer wavelengths (as in the case of J-aggregates). These H— and J-aggregates exhibit unique properties that differ from the properties of the bulk solid. For the H— or J-aggregates and polymer/dye complexes, molecular self-assembly has been used as a powerful technique to form organic molecular aggregates. However, few approaches were investigated to enable the control of the size of the molecular aggregates.

It would be very advantageous to be able to produce a polymeric nanocomposite template array that would enable one to incorporate size-tunable organic quantum dots, and a method of rapidly and economically producing a broad range of polymeric nanocomposites comprising size-tunable organic quantum dots and properties. Such materials would have applications in photonic crystals, optical Amplification devices, photoluminescence display, organic photovoltaics and bio- and chemical sensors, analogous to inorganic quantum dots materials (U.S. Pat. No. 6,710,366 to Lee, et al.; U.S. Pat. No. 6,819,692 to Klimov, et al.). In particular, the unusual physicochemical properties of the polymer composition of present invention make them especially suitable for applications in the field of optical devices including Raman amplification, such as, optical fibers, waveguides, Raman amplifiers, splitters, multiplexers, demultiplexers, attenuators, modulators, switches, and combination of such structures.

### SUMMARY OF THE INVENTION

One aspect of the present invention relates to polymeric nanocomposites comprising at least one functionalized polymer chain template comprising functional side-groups for self-assembly, and a plurality of size-tunable organic quantum dots formed by self-assembling onto the functionalized polymer chain template. The organic quantum dots may comprise organic compounds having pi-conjugated moieties and self-assembling functional groups. The self-assembled organic quantum dots may have a dimension of 0.1 nm to 300 nm.

The functionalized polymer chain template may comprise at least one type of monomer units containing functional groups for self-assembly. The type of monomer units containing functional groups for self-assembly can be called as type F monomer units. The functionalized polymer chain complete may comprise monomer units containing side-groups with no self-assembly function. The type of monomer units containing side-groups with no self-assembly function can be called as type NF monomer units. A consecutive sequence of the same repeated monomer units in the polymer chain can be called as a monomer block. The polymer chains may have a heterogeneous length distribution of type F monomer blocks causing by the separation of type NF monomer blocks. The polymer chains may comprise type NF monomer units containing acrylonitrile groups or —SH groups for binding to Ag or Au nanoparticles.

In one embodiment, the polymer chain template comprises a plurality of ionic functional groups (type F monomer units) for self-assembly and functional acrylonitrile groups (type NF monomer units). In the embodiment, the organic quantum dots may include organic compounds with pi-conjugated moieties and oppositely charge ionic groups.

Another aspect of the present invention relates to the preparation method of size-tunable organic quantum dots. The method includes self-assembling the organic molecules onto the functionalized polymer chain template. The size of the organic quantum dots is controlled by the length of the type F monomer blocks in the functionalized polymer chain templates. The polymeric nanocomposites may include a homogeneous or heterogeneous size-distribution of the organic quantum dots tunable by the functionalized polymer chain templates.

In a further aspect, the invention relates to a preparation method of coating the polymeric nanocomposites onto the surfaces of Ag or Au nanoparticles to achieve surface enhanced physiochemical properties, such as surface enhance Raman effect.

### BRIEF DESCRIPTION OF THE DRAWINGS

The method of producing polymeric nanocomposite comprising organic quantum dots according to the present invention, will now be described, by way of example only, reference being had to the accompanying drawings, in which:

FIG. 1 is a diagrammatic representation of the structures and preparation principle of the polymeric composition comprising self-assembled organic quantum dots.

FIG. 2 is an embodiment of preparing the polymeric composite comprising polymer chain templates including a copolymer chain template, and a distribution of organic quantum. The polymeric compositions may be made with (scheme 2) or without (scheme 1) coating onto the Ag-nanoparticles.

FIG. 3 shows the comparison of the Raman shift spectra of the polymer template, the polymeric nanocomposite having no Ag-nanoparticles and the polymeric nanocomposite having coated Ag-nanoparticles. The exemplary polymer composite has shown an unusually broad Raman shift band, and the intensity of the ultra-broad band is enhancable by Ag-nanoparticles.

FIG. 4 is the ¹³C NMR shift spectrum of the exemplary copolymer template.

FIG. 5 is the comparison of the FT-IR spectra of the exemplary copolymer template, small organic dye and the polymeric nanocomposite comprising organic quantum dots.

FIG. 6 is the comparison of the DSC thermograms of the copolymer template, and the polymeric nanocomposition comprising the self-assembled organic quantum dots.

FIG. 7 is the TEM image of the exemplary (G of FIG. 2) polymeric nanocomposition comprising the self-assembled organic quantum dots.

FIG. 8 is the TEM image of the exemplary (H of FIG. 2) Ag-nanoparticle-coated polymeric nanocomposition comprising the self-assembled organic quantum dots.

### DETAILED DESCRIPTION OF THE ILLUSTRATIVE EMBODIMENTS

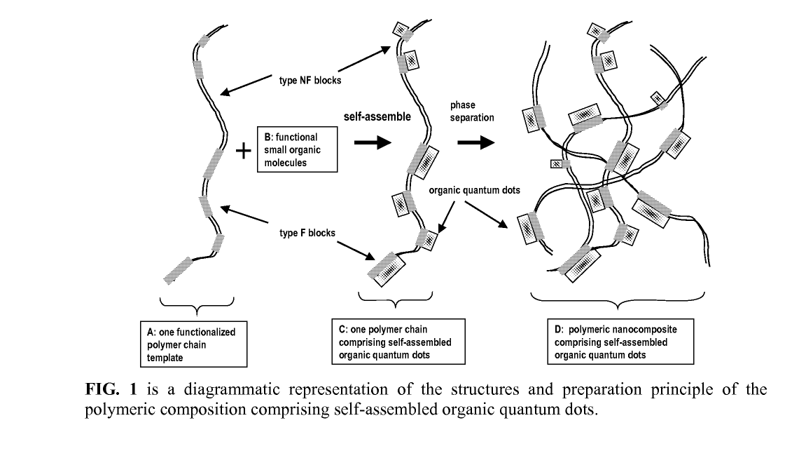

Referring to FIG. 1, the present invention relates to a polymeric composition (D) comprising functionalized polymer templates (A), and a plurality of organic quantum dots (C) self-assembled onto the polymer templates. Preferred functionalized polymer templates include copolymer molecules comprising a plurality of monomer units containing functional groups for molecular self-assembly and a plurality of monomer units containing functional groups not for molecular self-assembly. In one embodiment, the polymer template comprises a plurality of monomer units containing functional group capable of strongly chelating to Ag or Au nanoparticles. The polymer templates are preferably random copolymer with a broad distribution of molecular weight. The organic quantum dots are formed by a plurality of functional organic molecules self-assembled onto the polymer templates. Preferred organic molecules may contain one functional group for self-assembling with the polymer template and have one pi-conjugated system.

These and other aspects of the present invention are discussed further below.

1. Functionalized Polymer Chain Template

As seen in FIG. 1, polymeric composition (D) comprises at least one functionalized polymer chain template (A), and a plurality of organic quantum dots (C) self-assembled onto the polymer template. The polymer chain comprises a plurality of repeat monomer units. Suitable polymer chain comprises at least one type of monomer units containing functional groups for self-assembly (type F monomer units). Organic quantum dots are formed by self-assembling onto the functionalized polymer chain. The size of an individual organic quantum dot depends on the length of type F monomer block onto which it self-assembled. The polymer chain template may be a copolymer.

The polymer chain templates A preferably have a number of monomer units containing functional groups for self-assembly (type F monomer units), a number of monomer units containing groups without self-assembly function (type NF monomer units). The type NF monomer blocks separate the phases of the individual organic quantum dots to prevent their further aggregation. Otherwise, the quantum confinement effect can disappear when the size of organic molecular aggregates increase closely to their bulk materials. For each polymer chains, the molar ratio of type NF monomer units may be from 0 to close to 1.

The polymer chains may have a wide distribution of molecular weight, for example, with polydispersion index equals to 1-10. The polymer chains may be oligomers, i.e., polymer chains having fewer than 5 repeat units. Each polymer chain may have at least two to three type F monomer units in a continuous sequence. Preferred polymer chain may comprise type A monomer blocks at 0.1-100 nm in length. The length of type A monomer blocks in the polymer templates may have a heterogeneous or homogeneous size-distribution depending on the desired properties. The polymer chain templates should not have all polymer chains comprising type F monomer blocks longer than the size to observe the quantum confinement effect, for example, beyond 100 nm.

Preferred polymer chain templates have optical properties that allow the polymeric composition to be used in the formation of optical devices operable within at least one window in the wavelength region of from 400 to about 2000 nanometers. For example, in the absence of organic quantum dots, polymer templates of the invention may have optical attenuations of 0.4 dB cm⁻¹ or less, 0.3 dB dB cm⁻¹ or less, or 0.25 dB cm⁻¹ or less at a wavelength between about 800 and 2000 nm. Preferred polymer chain templates interfere as little as possible with optical properties of the organic quantum dots. In particular, preferred polymer templates interfere as little as possible with the energy of luminescence that may be emitted by the organic quantum dots.

Examples of suitable type F monomers from which to prepare polymer compositions of the invention include monomers containing pyridine groups, such as, including 4-vinyl-pyridine and 2-vinyl-pyridine, monomers containing amine groups, such as, N,N-dimethyl-ethoxy-metacrylate, monomer containing carboxylic group, for example, acrylic acid, and monomers containing sulfonic acid group, such as 4-sulfonic styrene. Type F monomers may be in the forms of their perfluronated counterparts.

Examples of suitable type NF monomers from which to prepare polymer compositions of the invention include in general any monomers other than type F, for example, methyl metacrylate, ethoxy acrylates. Type NF monomers may be monomers containing Ag-chelating groups, for example, acrylonitrile and thiol-ene. Type NF monomers may be in the forms of their perfluronated counterparts.

2. Organic Quantum Dots

The organic quantum dots (C in FIG. 1) may be formed by organic molecules containing functional groups for self-assembly. Preferred organic molecules may have a pi-conjugated moiety. Exemplary suitable organic molecules include organic dye molecules containing sulfonic groups, such as, metanil yellow dye, indigo cermine, methyl blue, Coomassie, and Cresol Red; organic dye molecules containing carboxylic groups, such as phenolphthalein; organic dye molecules containing amine groups, such as, ethyl green, Malachite green, methyl violet, fuchsine; and organic dye molecules containing hydrogen-bonding groups, such as aurin, to name but a few.

The size of an organic quantum dot is determined by the length of the type F monomer block in the polymer chain template onto which the organic quantum dot self-assembled. Preferred organic quantum dot have a size of 0.1-300 nm. The organic quantum dots may have a heterogeneous or homogeneous distribution of sizes depending on the desired application. The size distribution of organic quantum dots can be tuned by the length distribution of type F monomer blocks in the polymer chain templates.

Preferred organic quantum dots have optical properties that allow the polymeric composition to be used in the formation of optical devices operable within at least one window in the wavelength region of from 400 to about 2000 nanometers.

Preferred organic quantum dots are separated by type NF monomer blocks in the polymer chain template. The individual organic quantum dot preferably interferes as little as possible with optical properties with other organic quantum dots. In particular, preferred organic quantum dots mutually interfere as little as possible when the desired physical property is expected from a mixture of organic quantum dots with different sizes, for example, for a broad band in Raman shift spectrum.

3. Polymer Nanocomposites Comprising Self-Assembled Organic Quantum Dots

The polymer composites comprising self-assembled organic quantum dots may be formed by the self-assembly of the functionalized polymer templates with functional organic molecules. The self-assembly may be processed in an aqueous or other solvent solutions. The polymer composites comprising self-assembled organic quantum dots may be phase-separated from the solutions. Preferred polymer composites comprising self-assembled organic dots are in solid-state in bulk.

The self-assembled organic quantum dots in the polymer composite are preferably to be structurally stable in applications. The polymer composites may have a decomposition temperature higher than 250° C.

4. Ag or Au Nanoparticles-Coated Polymer Nanocomposites Comprising Self-Assembled Organic Quantum Dots

The polymer composites may be coated onto the Ag or Au nanoparticles to achieve surface enhanced physical properties of the organic quantum dots, such as the surface enhanced Raman effect. Preferred coating process include preparing the polymer chains comprising type NF monomers containing —CN or —SH groups. The polymer chains may be first dispersed into the Ag or Au nanoparticle colloidal solution. The self-assembly may be processed between Ag-coated functionalized polymer chain templates and functional organic molecules. Preferred Ag/Au nanoparticles-coated polymer composites are in solid-state in bulk.

The Ag/Au nanoparticle colloidal solutions are prepared via the reduction of Ag⁺ by NaBH₄. The preferred sizes of Ag/Au nanoparticles are less than 100 nm. The Ag/Au nanoparticles preferably may have a narrow distribution of sizes.

5. Ultra-Broad Band of Raman Shift Spectrum and Enhanced Raman Intensity by Coating the Polymeric Nanocomposites onto the Surface of Ag-Nanoparticles

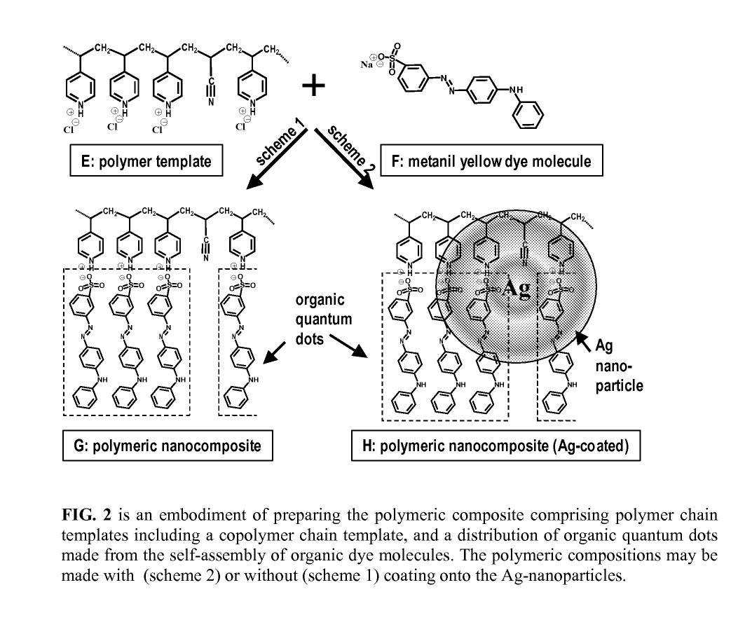

The exemplary polymeric nanocomposition (FIG. 2) has shown unusual physicochemical property, i.e. an unusually broad band for Raman shift. One particular application related to the ultra-broad Raman shift band of the exemplary polymeric nanocomposite is in the field of Raman amplification.

For Raman amplification, one great challenge is to seek materials having a broad Raman shift band to broaden the wavelength window of the amplified optical signals. The Raman shift spectra of materials have usually shown relatively sharp and isolated peaks due to discrete nature of molecular vibrations. Due to the broad vibration distribution of amorphous phases, the commonly used Raman amplification materials are inorganic glass materials, e.g. silica glass has a bandwidth of 210 cm⁻¹ for Raman shift. The most recently reported glass materials have shown a Raman shift bandwidth up to 350 cm⁻¹.

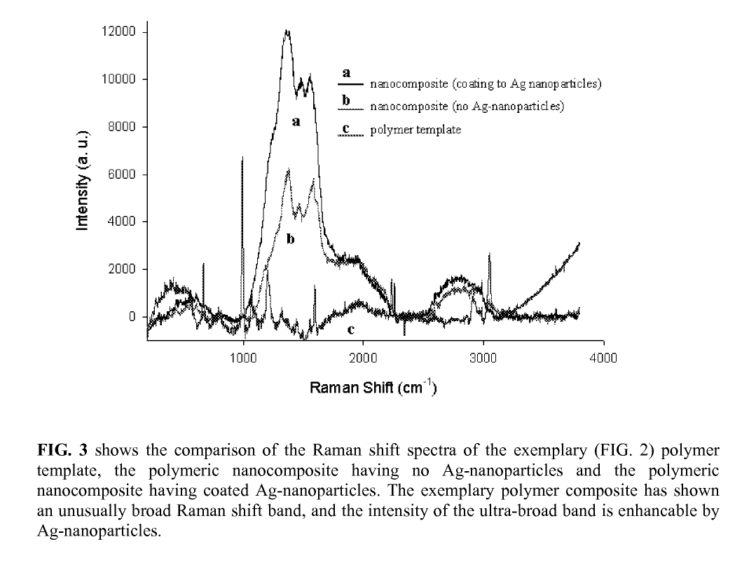

For polymeric composition comprising organic quantum dots, Raman scattering bands shift due to the size changes of the organic quantum dots. A combination of organic quantum dots with different sizes may broaden the Raman shift significantly. An ultra-broad Raman shift band has been detected from the exemplary nanocomposite of FIG. 3. For the exemplary polymer nanocomposites, an ultra-broad band of Raman shift up to 1200 cm⁻¹ has been detected, which is 3 times broader than currently known materials. This ultra-broad band is a strong evidence of the presence of organic quantum dots with different sizes in the polymeric nanocomposite. The preparation method of present invention can successfully tune the sizes of organic quantum dots.

FIG. 3 shows that the ultra-broad Raman shift band is further enhanced by surface enhanced Raman effect by a factor of 8 after coating onto the surface of Ag nanoparticles.

These usual physicochemical characteristics (ultra-broad Raman shift band and the enhancable Raman intensity) of the polymer composite make it particularly suitable for applications in the field of optical devices including Raman amplification, such as, waveguides, Raman amplifiers, splitters, multiplexers, demultiplexers, attenuators, modulators, switches, and combination of such structures.

### EXAMPLES

1. Preparation of Functionalized Polymer Chain Template

4-Vinylpyridine 10.0 mL, acrylonitrile 5.0 mL and initiator azo-bis-isobutylonitrile 1.0 g were mixed together and placed in a dropping funnel. A three-neck flask charged with 50.0 mL of 100% ethanol was heated to reflux, then the mixture of monomers and initiator was added dropwise over 30 minutes. The reaction was heated for 6 hours. After that, the polymer was precipitated by pouring the whole reaction mixture into large amount of cold deionized water. A white precipitate was obtained and purified by dissolving into ethanol, precipitated by adding and washed with cold water 3 times. Vacuum-drying was performed for the polymer at 60° C. for 2 days.

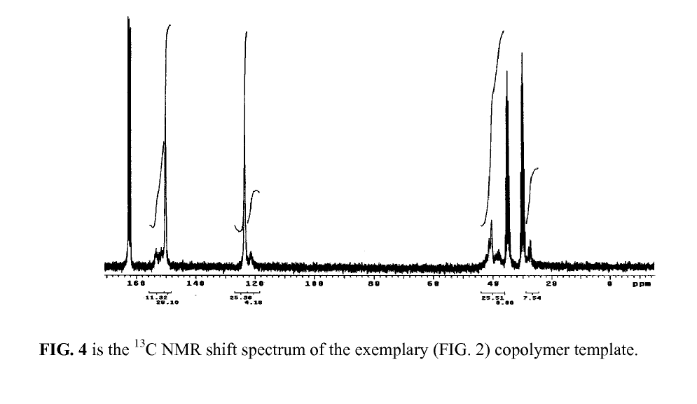

Poly(4-vinylpyridine-co-acrylonitrile) is random copolymer based on two evidences. First, copolymer synthesized via radical polymerization is usually random. Second, FIG. 4 shows that the ¹³C NMR shift peaks of the carbon atoms in the Poly(4-vinylpyridine-co-acrylonitrile) backbone are broadening and splitting due to existence of different connections of the type of two monomer. Therefore, the block length of 4-vinylpyridine are random, and has a broad distribution in the copolymer template.

2. Preparation of Polymer Nanocomposite Comprising Organic Quantum Dots

As shown in scheme 1 of FIG. 2, poly(4-vinylpyridine-co-acrylonitrile) was neutralized with concentrated HCl. An aqueous solution of 1.0×10⁻³ M 4-vinylpyridine unit was prepared. A metanil yellow aqueous solution 1.0×10⁻³ M was prepared. The titration of the polymer solution by metanil yellow was conducted at about 1-5 drops per second. Dark-color solid-particles settled out from the solution and were separated by gravity filtration. The final solid-state polymeric nanocomposite was washed twice with copious amounts of hot water, and dried under vacuum at 60° C. for 2 days.

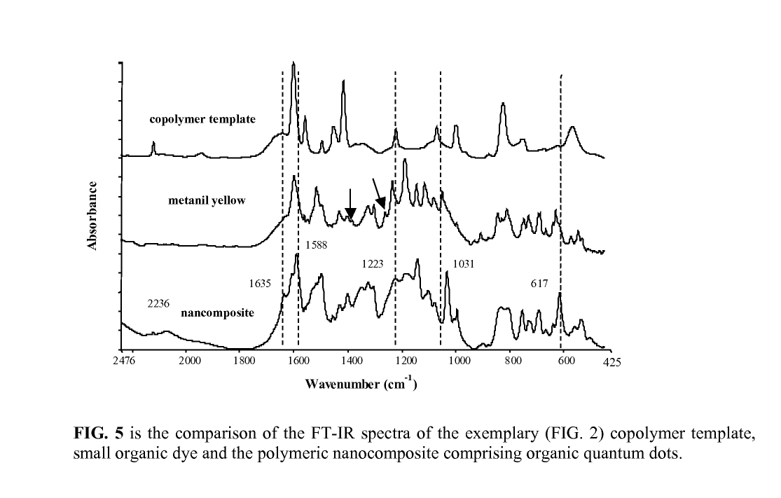

The FT-IR spectra of poly(4-vinylpyridine-co-acrylonitrile), metanil yellow dye molecules and the polymeric nanocomposites are shown in FIG. 5. Strong evidences in FIG. 5 have indicated that polymer templates are complexed with the organic quantum dots formed the metanil yellow dye molecules. For examples, the vibrational frequency at 2236 cm⁻¹, nitrile stretching in the copolymer, obviously lack in metanil yellow, was present in the complex indicating the formation PVPA-MY complex. The vibrational peaks of —SO₃⁻ groups has attached to the pyridinium functional groups indicated by the shift vibrational frequencies at 1023 cm⁻¹ and 1031 cm⁻¹.

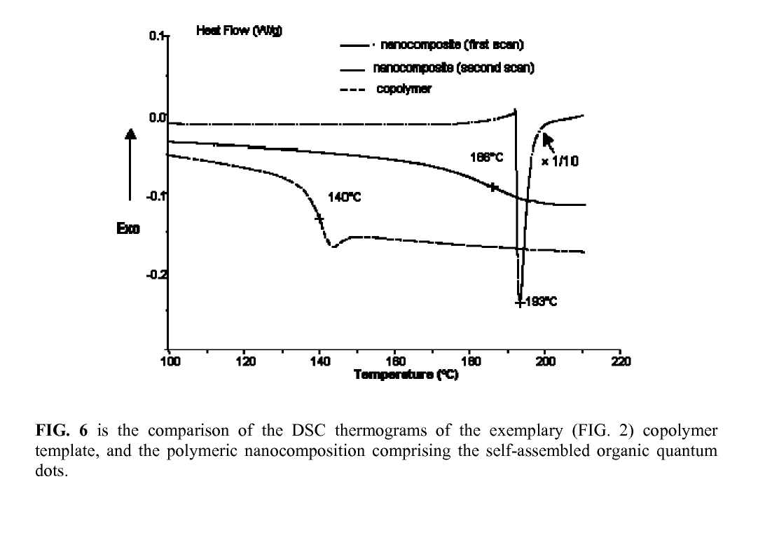

FIG. 6 shows the DSC thermograms of the polymer template and the polymeric nanocomposite comprising organic quantum dots. The obvious endothermic peak (at 193° C.) in FIG. 6 indicates a phase-transition process of well-ordered micro-phases, which are the micro-phases resulting from the orderly packing of metanil yellow dye molecules distributed among the polymer chain templates. This DSC analysis has proved that the self-assembled metanil yellow dye molecules exist as organic quantum dots in the polymeric nanocomposition.

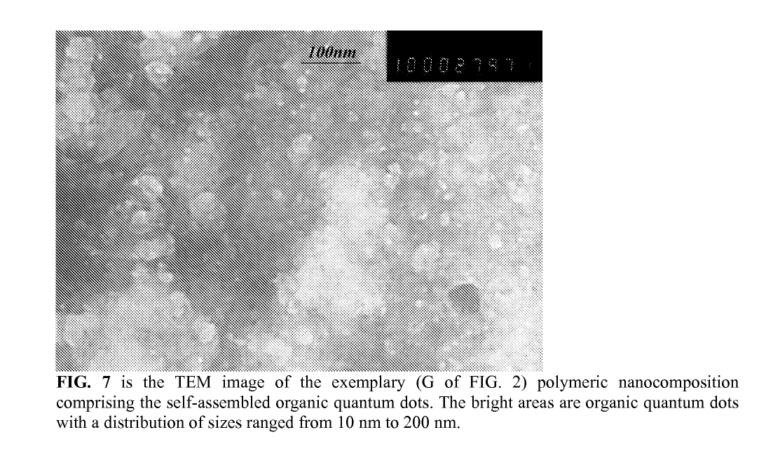

FIG. 7 shows the TEM image of the polymeric nanocomposite comprising organic quantum dots. The bright areas are organic quantum dots with a distribution of sizes ranged from 10 nm to 200 nm. The organic quantum dots are isolated due to the presence of the type NF monomer blocks so that the quantum size effects are preserved such as that shown in FIG. 3.

3. Preparation of Ag-Nanoparticle-Coated Polymer Nanocomposite Comprising Organic Quantum Dots

Referring to scheme 2 of FIG. 2, a water/ethanol mixture solution containing 2.5×10⁻⁴ M AgNO₃ and 2.5×10⁻⁴ M (VP molarity) poly(4-vinylpyridine-co-acrylonitrile) was prepared in a conical flask. Next, 0.6 mL of ice-cold, freshly prepared 0.1 M NaBH₄ solution was added to the AgNO₃ solution while stirring. The AgNO₃ solution turned yellow immediately after adding NaBH₄, indicating particle formation. In 2-5 h after preparation, the solution turned purple caused by aggregation and aging. These are dispersion solution of the copolymer-coated silver nanoparticles, which can be further ionized and undergo electrostatic self-assembly.

The above poly(4-vinylpyridine-co-acrylonitrile)-coated silver nanoparticle dispersion was neutralized by concentrated HCl. Meanwhile, deionized water was added to adjust the ratio of ethanol/water to ≦1. Successively, 2.5×10⁻⁴ M metanil yellow aqueous solution was added, similar to titration in polymer/dye complex without silver. Dark-color particles were generated in the solution due to complex of Ag-chelating polyelectrolyte and dye. The final product of polymeric nanocomposite (coating to Ag-nanoparticles) was isolated by gravity filtration, washed twice with copious amounts of hot water, and was placed in an oven and vacuum-dried at 60° C. for 2 days.

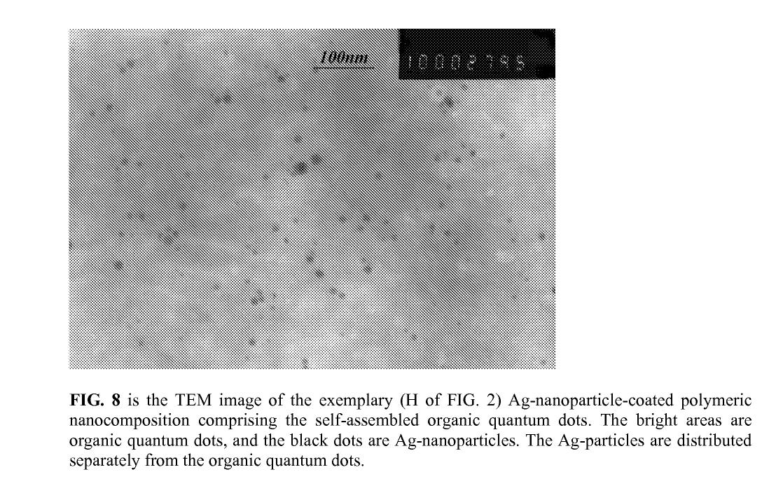

FIG. 8 shows the TEM image of the Ag-nanoparticle-coated polymeric nanocomposite comprising organic quantum dots. The bright areas are organic quantum dots, and the black dots are Ag-nanoparticles. The Ag-nanoparticles show to be separated from the organic quantum dots because the Ag-nanoparticles are bound to the type NF monomer blocks while organic quantum dots are present in the type F monomer blocks. This provides a direct structural evidence of the claimed polymeric nanocomposites comprising organic quantum dots as shown in the schematic diagram of FIG. 1.

The enhanced intensity of the Raman shift band of the polymeric composite in FIG. 3 has proved that the polymeric composites have been coated onto the surface of Ag-nanoparticles.

What is claimed is:

1. A composition of matter, comprising: at least one functionalized polymer chain template having at least one type of functional groups for self-assembly (ionic groups, H-bonding groups, van der Waals interactions groups, or reactive chemical groups); and a plurality of size-tunable organic quantum dots formed by organic molecules self-assembling onto the polymer chain template.

2. The composition of matter of claim 1, wherein the polymer chains include at least one type of functional groups for molecular self-assembly (ionic groups, H-bonding groups, van der Waals interaction groups or reactive chemical groups).

3. The composition of matter of claim 1, wherein the polymer chains include monomer units having side-groups with no self-assembly function.

4. The composition of matter of claim 1, wherein the polymer chains include monomer units having functional groups of chelating Ag or Au nanoparticles.

5 The composition of matter of claim 1, wherein the organic quantum dots have heterogeneous distribution of sizes tunable by the functionalized polymer template.

6. The composition of matter of claim 1, wherein the organic quantum dots include self-assembled organic molecules with pi-conjugated moieties.

7. A method of preparing organic quantum dots in the composition of matter of claim 1.

8. A method of coating the composition of matter of claim 1 onto the surface of Ag or Au nanoparticles.

9. The composites of claim 1, wherein the self-assembled organic quantum dots have an unusually broad Raman shift band that is especially suitable for use in Raman amplification.
